(19) United States
(12) Patent Application Publication
(10) Pub. No.: US 2004/0254845 A1
(43) Pub. Date: Dec. 16, 2004

(54) Storage medium having entertainment value stored thereon

(76) Inventors: Matthew James Dozier, Loveland, CO (US); Jonathan Firooz, Vancouver, WA (US); Raquel Pacheco, Trujillo, NM (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/461,599

(22) Filed: Jun. 12, 2003

(51) Int. Cl. G06F 17/60

(52) U.S. Cl. 705/26

(57) ABSTRACT

A system and method for storing entertainment value, is disclosed. In one embodiment, the system comprises an electronic storage medium having a memory. The electronic storage medium is configured to store entertainment value corresponding to an entertainment event. The system also comprises a computing device configured to couple to the electronic storage medium and store the entertainment value on the electronic storage medium.

### BACKGROUND

The present invention relates generally to the electronic storage of value, and, more particularly, to an apparatus including a storage medium having entertainment value stored thereon.

Attendance at entertainment events and venues is at an all time high. With many events, a ticket is typically purchased prior to the date of the event, and the ticket is customarily mailed to the purchaser. The purchaser typically stores the ticket until the date and time of the event. When it is time to attend the event, the purchaser takes the ticket and travels to the event venue, and gains entrance to the event by displaying and exchanging the ticket for entrance to the venue. Concerts, sporting events, and shows are some examples of such events in which an entrance ticket is purchased prior to the date of the event and physically carried to the event.

Such a ticket purchase and exchange system has many drawbacks. In some instances, for example, the ticket must be mailed to the recipient, who must then store the ticket until the date and time of the event. Further, the purchaser must remember to retrieve and bring the ticket to the event. In some instances, the purchaser must maintain control over the physical ticket for a long period of time and must remember to bring the ticket to the event to gain access to the venue. Further still, in the case of multiple tickets, the purchaser must maintain control over and bring multiple tickets to the event.

Therefore, an improved way of purchasing access to and gaining entrance to an event is desirable.

### SUMMARY

In one embodiment, a system for storing entertainment value comprises an electronic storage medium having a memory, the electronic storage medium configured to store entertainment value corresponding to an entertainment event, and a computing device configured to couple to the electronic storage medium and store the entertainment value on the electronic storage medium.

In another embodiment, a system for storing entertainment value comprises a server computer having a memory, the server computer configured to store entertainment value corresponding to an entertainment event, and a computing device configured to electronically access an electronic vendor and obtain entertainment value from the electronic vendor and store the entertainment value on the memory associated with the server computer and provide an identifier associated with the entertainment value. Other systems, methods, and related computer readable media are also disclosed.

### BRIEF DESCRIPTION OF THE DRAWINGS

The system and method for storing entertainment value, as recited in the claims, can be better understood with reference to the following drawings. The components within the drawings are not necessarily to scale relative to each other; emphasis instead is placed upon clearly illustrating the principles of the system and method for storing entertainment value.

FIG. 1 is a schematic diagram illustrating an embodiment of the system and method for storing entertainment value.

FIG. 2 is a block diagram illustrating an embodiment of the computer and the data server of FIG. 1.

FIG. 3 is a block diagram illustrating the venue of FIG. 1.

FIG. 4 is a flow chart illustrating the operation of the client entertainment value software and the server entertainment value software of FIG. 2 when purchasing entertainment value and storing the entertainment value on the storage medium of FIG. 1.

FIG. 5 is a flow chart illustrating the operation of the system and method for storing entertainment value when used to gain access to an event location.

FIG. 6 is a flow chart illustrating the operation of an alternative embodiment of the system and method for storing entertainment value.

### DETAILED DESCRIPTION

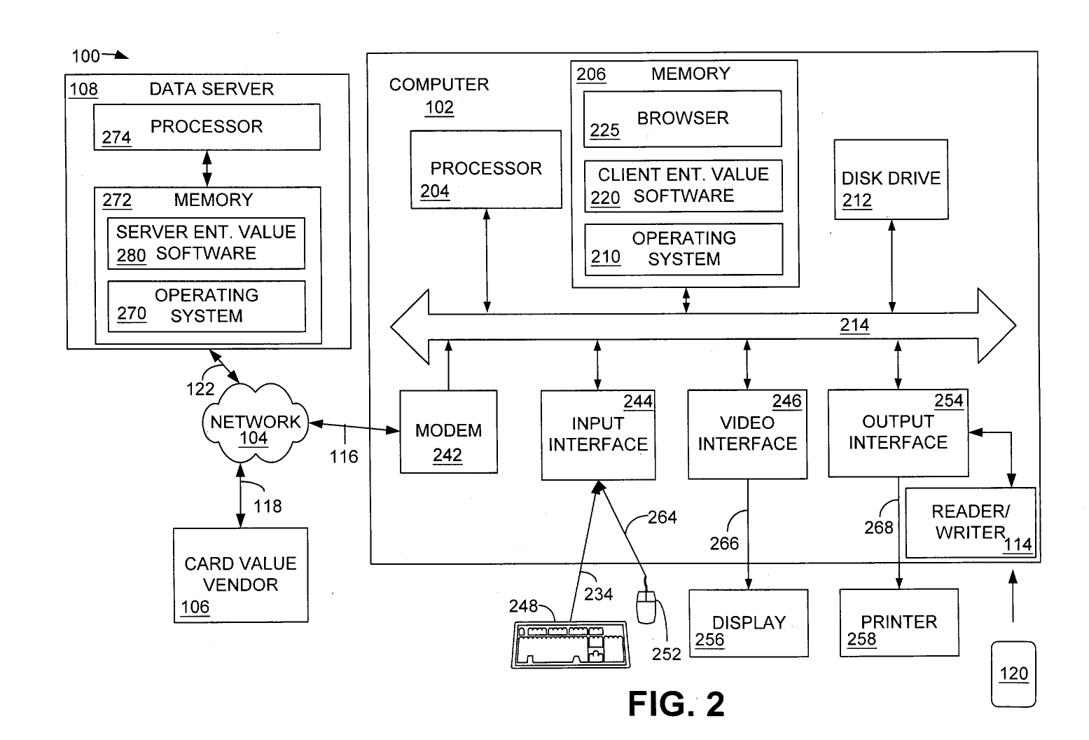

The system and method for storing entertainment value can be implemented as a storage medium having entertainment value. Placing value of the storage medium can be implemented in software (e.g., firmware), hardware, or a combination thereof. In the currently contemplated best mode, the storage medium having entertainment value is implemented using a combination of hardware and software. The software portion of the system and method for storing entertainment value is executed by a special or general-purpose computer, such as a personal computer (PC), workstation, minicomputer, or mainframe computer. An example of a general-purpose computer that can implement the software of the storage medium having entertainment value is shown in FIG. 2.

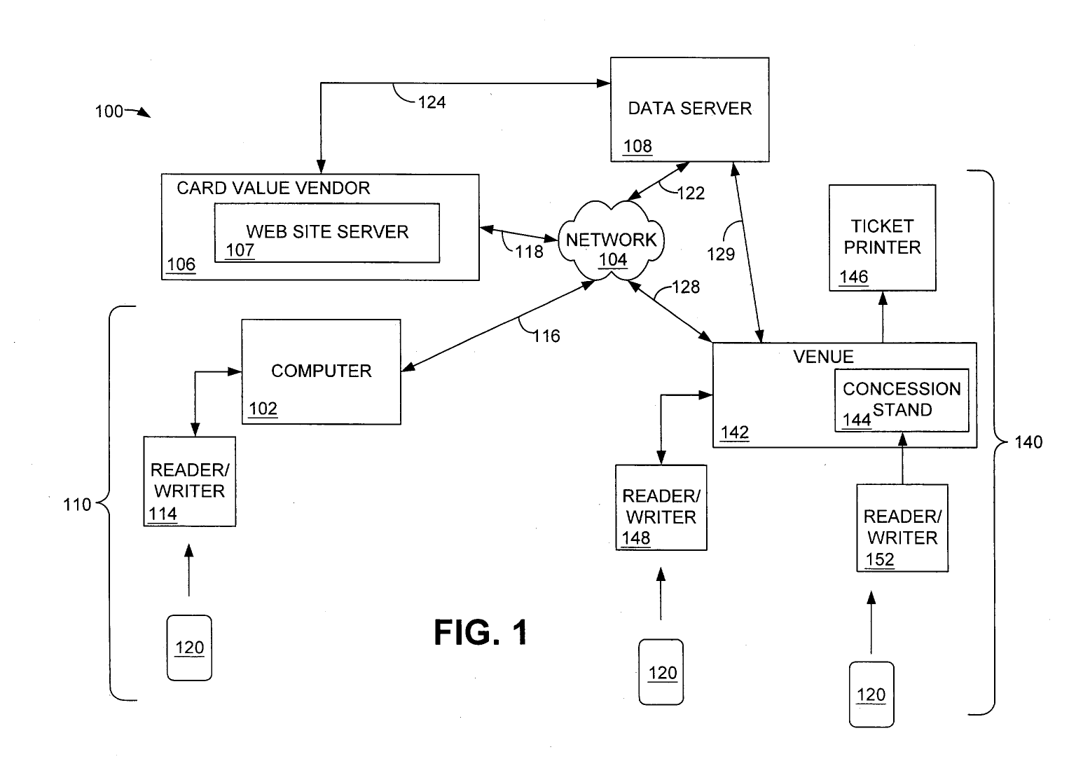

FIG. 1 is a schematic diagram 100 illustrating an embodiment of the system and method for storing entertainment value. For purposes of this description, the system 100 will be referred to as the “entertainment value” system. In one embodiment, the entertainment value system 100 includes a storage medium, to be described below, that stores entertainment value for one or more individuals to attend one or more events. The entertainment value can be used to gain access to various events and facilities, depending upon the nature of the entertainment value stored on the storage medium.

The system 100 generally includes a customer premises 110 and an event location 140. The customer premises 110 includes a computer 102 coupled to a network 104 via connection 116. The network 104 can be any type of network, and, in this embodiment, is preferably a wide area network, such as the Internet. The computer 102 is coupled to a reader/writer 114 into which a storage medium 120 can be inserted. The reader/writer 114 can be integrated into the computer 102, or can be a separate peripheral device. The storage medium 120 can be, for example, any medium having memory that can store information. For example, the storage medium 120 can be a compact flash (CF) memory media, a Memory Stick®, or a credit card-like medium containing a magnetic stripe, medium or layer on which information can be stored. The reader/writer 114 is capable of reading information from the storage medium 120 and writing information to the storage medium 120.

A card value vendor 106 is coupled to the network 104 via connection 118. The connections 116 and 118 can be, for example, high speed digital subscriber line (DSL) connections, or alternatively can be any other type of connection over which a computer 102 or a card value vendor 106 can communicate with the network 104. In a preferred embodiment, the card value vendor 106 includes a web site server 107, which can be used to host a World Wide Web (WWW) site. The card value vendor can include, or can be coupled to, a data server 108 either through the network 104 via connection 122 or through a separate connection, such as connection 124. The card value vendor 106 can be any entity from which a user of the system 100 wishes to purchase entertainment value. The data server 108 stores, records, and otherwise tracks the entertainment value that is applied to the storage medium 120 by the card value vendor 106.

The system 100 allows a user to purchase entertainment value from the card value vendor 106 and store that entertainment value on the storage medium 120. For example, a user located at the customer premises 110 might use the computer 102 to browse to a web site on the web site server 107 that is maintained by the card value vendor 106. While browsing the web site a user may choose to purchase, for example, tickets to a sporting event. After the user purchases tickets to the particular event, the user is prompted to insert the storage medium 120 into the reader/writer 114. When the purchase confirmation is provided by the card value vendor 106 and received by the computer 102, the reader/writer 114, under the direction of the computer 102, writes the event value to the storage medium 120. In this manner, the “ticket” for the purchased event, or more accurately, the entertainment value of the ticket, is stored and maintained on the storage medium 120. As will be described in further detail below, instead of mailing paper tickets to the user, the “value” of the tickets for the event are maintained on the storage medium 120. When the time arrives to attend the event, the user transports the storage medium 120 to the event location where the purchased event will take place. In this manner, the mailing and maintenance of paper tickets is avoided. Further, value for multiple events and for multiple individuals to attend the multiple events can be stored on a single storage medium 120.

The system 100 also includes an event location 140. The event location 140 includes a venue 142. The venue 142 includes, or is coupled to, a reader/writer 148, which is similar to the reader/writer 114, into which the storage medium 120 can be inserted. The venue 142 also includes, or is coupled to, a ticket printer 146, and is optionally coupled to the network 104 via connection 128, which is similar to connections 116 and 118. The venue 142 may also include one or more concession stands, an exemplary one of which is illustrated using reference numeral 144, which is coupled to a reader 152.

In one embodiment, after the user has purchased entertainment value and stored the entertainment value on the storage medium 120, the user of the system 100 inserts the storage medium 120 into the reader 148 to gain access to the venue 142. The reader/writer 148 deducts the entertainment value corresponding to the event from the storage medium, and the user gains access to the venue 142. If the venue 142 is one in which a paper ticket is used, the ticket printer 146 can print the ticket just prior to the entertainment value being deducted from the storage medium 120 while the storage medium 120 is inserted into the reader 148.

In another embodiment, additional value can be stored on the storage medium 120. For example, if a user wishes to attend an event at the venue 142 and wishes to, for example, not carry any cash, additional value can be stored on the storage medium 120 using the reader/writer 114. In this manner, the storage medium 120 can be used to purchase; for example, food, beverages, or other concessions at the concession stand 144 using only the storage medium 120.

In one embodiment, the venue 142 is not coupled to the data server 108, either directly or via the network 104. Such an embodiment may be desirable for those event locations in which communication with the data server may be costly, inconvenient, or undesired for other reasons. In such an embodiment, the user of the system should maintain close control over the storage medium since this medium provides proof of purchase and access to the event. Such an implementation includes many advantages over the use of a conventional paper ticket. For example, a single storage medium 120 can be stored safely in the user's wallet along with other items. Further, in such an embodiment, the data server 108 maintains a record of the value on the storage medium 120 so if the storage medium 120 is lost prior to the event, the value of the card can be verified and restored on another storage medium 120.

In another embodiment, the venue 142 can be coupled to the data server 108 via a direct connection 129, or via the network 104 via connections 122 and 128. In this embodiment, the data server 108 can be accessed by the venue 142 so the data server can be updated in real time as the event value is deleted from the storage medium 120. Further, if the storage medium 120 is lost, or forgotten, an identification number, or other verification system, can be used by the user at the venue 142 to gain access to the event, even if the storage medium 120 is lost or forgotten.

FIG. 2 is a block diagram illustrating the computer 102 and the data server 108 of FIG. 1. The computer 102 can be a general-purpose computer. The computer 102 and the data server 108 can implement the different portions of the entertainment software to be described below. The client entertainment value software 220, the server entertainment value software 280, and other software and hardware elements (to be discussed with respect to FIG. 2) work in unison to implement the system and method for storing entertainment value.

Generally, in terms of hardware architecture, as shown in FIG. 2, the computer 102 includes a processor 204, memory 206, a disk drive 212, an input interface 244, a video interface 246 and an output interface 254 that are connected together and can communicate with each other via a local interface 214. The local interface 214 can be, for example but not limited to, one or more buses or other wired or wireless connections, as is known in the art. The local interface 214 may have additional elements, which are omitted for simplicity, such as buffers (caches), drivers, and controllers, to enable communications. Further, the local interface 214 includes address, control, and data connections to enable appropriate communications among the aforementioned components.

The processor 204 is a hardware device for executing software that can be stored in memory 206. The processor 204 can be any custom made or commercially available processor, a central processing unit (CPU) or an auxiliary processor among several processors associated with the computer 102, and a microchip-based microprocessor or a macroprocessor.

The memory 206 can include any one or combination of volatile or non-volatile memory elements. Moreover, the memory 206 may incorporate electronic, magnetic, optical, and/or other types of storage media. Note that the memory 206 can have a distributed architecture, where various components are situated remote from one another, but can be accessed by the processor 204.

The input interface 244 can receive commands from, for example, a mouse 252 via connection 264 and a keyboard 248 via connection 234, and can transfer those commands over the local interface 214 to the processor 204 and the memory 206.

The video interface 246 supplies a video output signal via connection 266 to the display 256. The display 256 can be a conventional CRT based display device, or can be any other display device, such as a liquid crystal display (LCD) or other type of display.

The output interface 254 sends printer commands via connection 268 to the printer 258. The modulator/demodulator (modem) 242 can be any communication device capable of connecting the computer 102 to an external network 104 via connection 116. The network 104 may be a wide area network (WAN) or local area network (LAN).

The reader/writer 114 also couples to the local interface 214 via the output interface 254 and is configured to receive the storage medium 120. The reader/writer 114 can read information from the storage medium 120 and can write information to the storage medium 120. In a preferred embodiment, the reader/writer 114 couples to the local interface 214 via a universal serial bus (USB) interface, or other interface.

The software in memory 206 may include one or more separate programs, each of which comprises an ordered listing of executable instructions for implementing logical functions. In the example of FIG. 2, the software in the memory 206 includes the client entertainment value software 220 and a suitable operating system (O/S) 210. A preferred embodiment uses a Windows-based operating system and/or systems that have a USB interface or a similar interface that is capable of performing operations over that interface via software that is downloaded by way of the browser 225. The operating system 210 essentially controls the execution of other computer programs, such as the client entertainment value software 220, and provides scheduling, input-output control, file and data management, memory management, and communication control and related services. The processor 204 and operating system 210 define a computer platform, for which application programs, such as the client entertainment value software 220, in higher level programming languages are written. The client entertainment value software 220 includes the software that allows the computer 102 to communicate with the data server 108 and place entertainment value on the storage medium 120.

The system 100 also includes a data server 108 coupled to the network 104. The data server includes a processor 274 coupled to a memory 272. The processor 274 can be similar to the processor 204, but is specific to performing the functions of the data server 108. Similarly, the memory 272 can be similar to the memory 206. The memory 272 includes an operating system (O/S) 270 and the server entertainment value software 280. The server entertainment value software 280 operates in cooperation with the client entertainment value software 220 to enable a user of the system to purchase entertainment value from a card value vendor 106 (FIG. 1) and place that value on the storage medium 120.

When portions of the system and method for storing entertainment value are implemented in software, as is shown in FIG. 2, the client entertainment value software 220 and the server entertainment value software 280 can be stored on any computer-readable medium for use by or in connection with any computer related system or method. In the context of this document, a computer-readable medium is an electronic, magnetic, optical, or other physical device or means that can contain or store a computer program for use by or in connection with a computer related system or method. The client entertainment value software 220 and the server entertainment value software 280 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

The hardware components of the system and method for storing entertainment value can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), or a field programmable gate array (FPGA), for example.

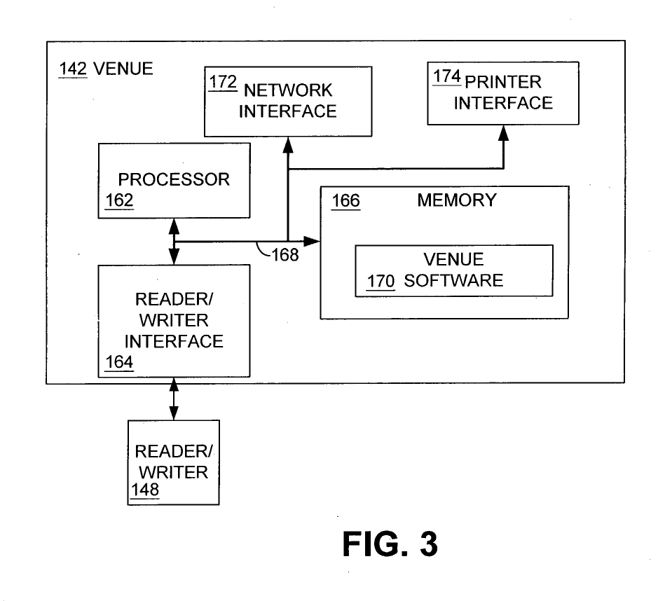

FIG. 3 is a block diagram illustrating the venue 142 of FIG. 1. The venue 142 includes a processor 162 in communication with reader/writer interface 164 and memory 166 via logical interface 168. The reader/writer interface 164 couples the reader/writer 148 to the venue 142 via a bi-directional connection. The memory 166 includes venue software 170. In one embodiment of the system and method for storing entertainment value, the venue software 170 includes the logic used by the venue 142 to determine the entertainment value contained in the storage medium 120.

In alternative embodiments of the system and method for storing entertainment value, the venue 142 also includes a network interface 172 and a printer interface 174 coupled to the processor 162 and memory 166 via the logical interface 168. In an embodiment in which the venue communicates with the data server 108, the network interface can provide a connection to the network 104 as described above.

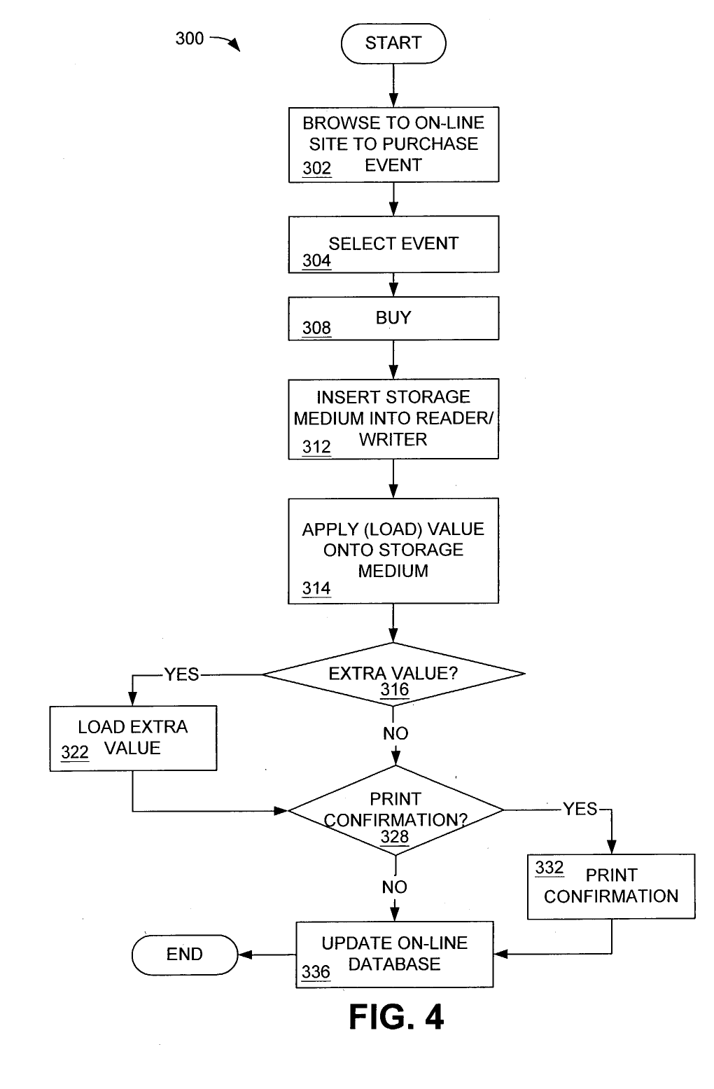

FIG. 4 is a flow chart 300 illustrating the operation of the client entertainment value software 220 and the server entertainment value software 280 when used to purchase entertainment value and store the entertainment value on the storage medium 120. In block 302 a user of the system 100 uses the computer 102 to browse to an on-line site to purchase entertainment value. The on-line site can be the web site maintained by the web site server 107 of the card value vendor 106 (FIG. 1). In block 304 the user selects an event to attend. In block 308 the user purchases entertainment value associated with the event using, for example, a secure credit card transaction between the computer 102 and the card value vendor 106 of FIG. 1. In block 312, the user inserts the storage medium 120 into the reader/writer 114. In block 314, the reader/writer 114 applies the appropriate entertainment value to the storage medium 120.

In block 316 it is determined whether any additional value is to be added to the storage medium 120. For example, additional value that can be redeemed for cash at the event location can be added to the storage medium 120. If it is determined in block 316 that additional value is to be added to the storage medium 120, then, in block 322, the additional value is added to the storage medium 120 using the reader/writer 114. If, in block 316, it is determined that no additional value is to be added to the storage medium 120, then, in block 328, it is determined whether a printed confirmation of the transaction is desired. If a printed confirmation of the transaction is desired, then, in block 332, the printer 258 (FIG. 2) prints a confirmation. In block 336, the data server 108 is updated with the transaction, and the process ends.

As another example of value that can be added to the card by the user, or placed on the card by the card value vendor 106 via the computer 102 and the reader/writer 114, coupons, or other incentives can be added to the storage medium 120. Furthermore, multiple events, multiple tickets per event, and other combinations of entertainment value can be simultaneously stored on the storage medium 120.

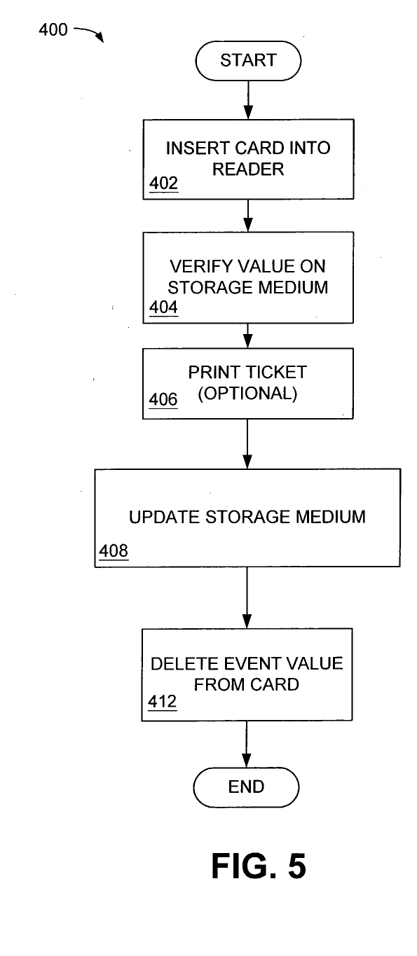

FIG. 5 is a flow chart 400 illustrating the operation of the method for storing entertainment value when used to gain access to an event location. In block 402, a user inserts the storage medium 120 into the reader 148 (FIG. 1) located at the event location 140 (FIG. 1). In block 404, the venue 142 verifies the value on the storage medium. In block 406, the ticket printer 146 (FIG. 1) optionally prints a ticket at the event location 140. In block 408, the storage medium, which is still inserted in the reader/writer, is updated to reflect that a ticket has been printed. In block 412, the event value is deleted from the card and the user is allowed access to the venue 142.

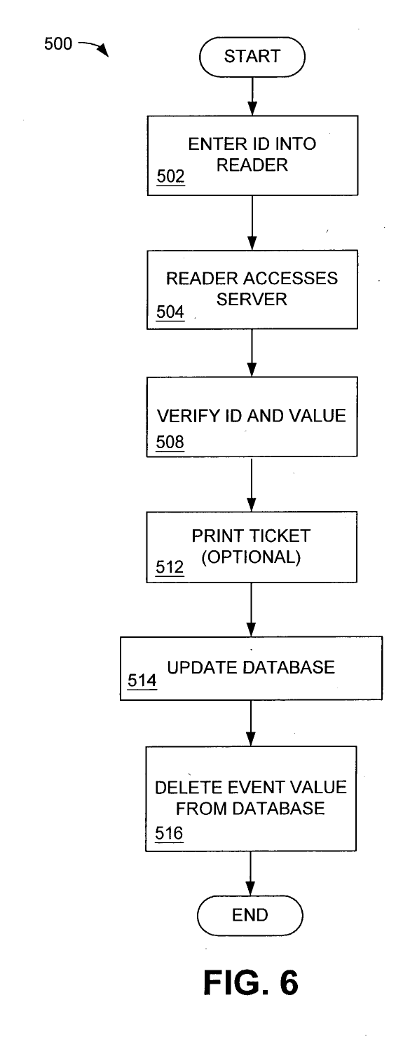

FIG. 6 is a flow chart 500 illustrating the operation of an alternative embodiment of the apparatus and method for storing entertainment value. In the embodiment illustrated in FIG. 5, the venue 142 communicates with the data server 108. In such an embodiment, the entertainment value is stored on the data server 108 and the storage medium 120 need not necessarily be used at the venue 142 to gain access to the event. In FIG. 6 though, an identification code, or number, may be carried by the user and entered at the venue 142 to allow the user access to the event. In block 502 a user of the system enters an identification number, or code, into the reader/writer 148. In this embodiment, the reader/writer 148 may include, for example, a keypad, or other input device. In block 504, the reader/writer 148 accesses the data server 108 via a modem, transceiver, or other networked Internet connection (not shown) located at the venue 142 and through the connection 128. In block 508 the data server 108 verifies the identification information entered in block 502 and verifies the entertainment value associated with the identification information. In block 512, the ticket printer 146 (FIG. 1) optionally prints a ticket at the event location 140. In block 514, the data server 108 is updated to reflect that a ticket has been printed. In block 516 the event value is deleted from the data server 108 and the user is admitted to the venue 142.

It will be apparent to those skilled in the art that many modifications and variations may be made to the preferred embodiments of the apparatus and method for storing entertainment value, as set forth above, without departing substantially from the principles of the system and method for storing entertainment value. All such modifications and variations are intended to be included herein within the scope of the present invention, as defined in the claims that follow.

What is claimed is:

1. A system for storing entertainment value, comprising:
an electronic storage medium having a memory, the electronic storage medium configured to store entertainment value corresponding to an entertainment event; and
a computing device configured to couple to the electronic storage medium and store the entertainment value on the electronic storage medium.

2. The system of claim 1, wherein the electronic storage medium is an electronic card.

3. The system of claim 1, wherein the electronic storage medium is a memory card.

4. The system of claim 1, further comprising:
a reader located at an event venue, the reader configured to couple to the electronic storage medium and deduct value from the electronic storage medium, the value corresponding to a cost of attending the entertainment event.

5. The system of claim 1, further comprising a server computer coupled to the computing device, the server computer configured to store a copy of the entertainment value that is stored on the electronic storage medium.

6. The system of claim 1, wherein the entertainment value comprises concession item value.

7. The system of claim 4, wherein the reader further comprises a ticket printer.

8. The system of claim 6, further comprising a server computer coupled to the reader, the server computer configured to deduct the entertainment value that is stored on the electronic storage medium.

9. A method for storing entertainment value, comprising:
providing an electronic storage medium having a memory;
purchasing entertainment value; and
storing the entertainment value on the electronic storage medium.

10. The method of claim 9, further comprising storing the entertainment value on an electronic card.

11. The method of claim 9, further comprising storing the entertainment value on a memory card.

12. The method of claim 9, further comprising:
providing a reader located at an event venue;
coupling the reader to the electronic storage medium; and
deducting value from the electronic storage medium, the value corresponding to a cost of attending the entertainment event.

13. The method of claim 9, further comprising storing a copy of the entertainment value on a server computer.

14. The method of claim 12, further comprising printing a ticket at the event venue.

15. The method of claim 12, further comprising:
coupling a server computer to the reader; and
deducting the entertainment value that is stored on the electronic storage medium from the server computer.

16. A system for storing entertainment value, comprising:
a server computer having a memory, the server computer configured to store entertainment value corresponding to an entertainment event; and
a computing device configured to electronically access an electronic vendor and obtain entertainment value from the electronic vendor and store the entertainment value on the memory associated with the server computer and provide an identifier associated with the entertainment value.

17. The system of claim 16, further comprising:
an access device located at an event venue, the access device configured to receive the identifier associated with the entertainment value; and
a connection between the access device and the server computer, where the server computer verifies the identifier and allows access to the event venue.

18. The system of claim 16, wherein the entertainment value is deleted from the server computer.

19. The system of claim 17, further comprising a ticket printer associated with the access device.

20. A method for storing entertainment value, comprising:
providing a computing device configured to electronically access an electronic vendor and obtain entertainment value from the electronic vendor;
providing a server computer having a memory;
storing entertainment value on memory associated with the server, the entertainment value corresponding to an entertainment event; and
providing an identifier associated with the entertainment value.

21. The method of claim 20, further comprising:
providing an access device located at an event venue, the access device configured to receive the identifier associated with the entertainment value;
providing a connection between the access device and the server computer;
verifying the identifier; and
allowing access to the event venue based on the identifier.

22. The method of claim 20, further comprising deleting the entertainment value from the server computer.

23. The method of claim 21, further comprising printing a ticket at the event venue.
